(19) United States
(12) Patent Application Publication
(10) Pub. No.: US 2025/0268142 A1
(43) Pub. Date: Aug. 28, 2025

(54) System and Method to Control Merger Belt Slip

(71) Applicant: Deere & Company, Moline, IL (US)

(72) Inventors: Mahi Agrawal, Pune (IN); Sameer Gorivale, Pune (IN)

(21) Appl. No.: 18/586,738

(22) Filed: Feb. 26, 2024

(51) Int. Cl. A01D 57/20; A01D 34/00

(52) U.S. Cl. CPC A01D 57/20; A01D 34/008

(57) ABSTRACT

The present disclosure is a system for controlling an agricultural machine. The system has a merger belt assembly comprising a merger belt, a controller configure to selectively control the merger belt assembly, and a user input configured to provide a desired belt speed command to the controller indicating a desired operating speed of the merger belt. The controller provides instructions to the merger belt assembly of the agricultural machine to operate the merger belt at the desired operating speed. Further, the controller is configured to monitor an actual merger belt speed of the merger belt assembly and provide a response when the actual merger belt speed is outside of a desired operating speed threshold established by the desired belt speed command.

### FIELD OF DISCLOSURE

The present disclosure relates to an agricultural vehicle having one or more conveyor and more specifically to selectively controlling the one or more conveyor based on operating conditions.

### BACKGROUND OF THE DISCLOSURE

Known agricultural machines, such as windrowers, often have a merger belt configured to redirect harvested material away from a path of travel of the windrower. The speed of the merger belt is typically established by the user to reposition the harvested material to the desired location. However, if the user improperly sets the merger belt speed for the operating conditions of the agricultural machine, the harvested material may clog the agricultural machine, among other things.

### SUMMARY

One embodiment is a system for controlling an agricultural machine. The system has a merger belt assembly comprising a merger belt, a controller configure to selectively control the merger belt assembly, and a user input configured to provide a desired belt speed command to the controller indicating a desired operating speed of the merger belt. The controller provides instructions to the merger belt assembly of the agricultural machine to operate the merger belt at the desired operating speed. Further, the controller is configured to monitor an actual merger belt speed of the merger belt assembly and provide a response when the actual merger belt speed is outside of a desired operating speed threshold established by the desired belt speed command.

In one example of this embodiment, the controller is configured to provide one or more of decreasing a header speed, increasing a merger belt speed, reducing a vehicle speed, and adjusting a roll gap as the response. In part of this example, the controller is configured to automatically execute the response.

In yet another example of this embodiment, the controller is configured to provide a recommended belt speed to a user via a display. In part of this example, the controller is configured to determine the recommended belt speed based on operating conditions of the agricultural machine. In one aspect of this part, the controller is configured to consider one or more of a header speed, a vehicle speed, and a roll gap as operating conditions of the agricultural machine.

In yet another example of this embodiment the controller is configured to automatically adjust the desired operating speed as part of the response. In part of this example, the controller is configured to automatically adjust the desired operating speed based on operating conditions of the agricultural machine. In one aspect of this part, the controller is configured to consider one or more of a header speed, a belt slip, a vehicle speed, and a roll gap for the operating conditions.

In another example of this embodiment, the controller is configured to determine the desired belt speed command from data from the agricultural machine, the data comprising one or more of a header speed, a throw distance, and a header load. In part of this example, the data comprises the throw distance and the throw distance is input by a user through the user input.

Yet another embodiment of this disclosure is a method for managing a merger belt speed of a merger belt assembly on an agricultural machine. This method includes evaluating operating conditions of the agricultural machine with a controller, determining a desired belt speed of a belt of the merger belt assembly with the controller based on the operating conditions, instructing the merger belt assembly to operate the belt at the desired belt speed, monitoring an actual belt speed of the belt of the merger belt assembly with the controller through a sensor, identifying when the actual belt speed is not within a threshold established by the desired belt speed with the controller, and generating an automatic response on the agricultural machine with the controller when the desired belt speed is not within the threshold.

In one example of this embodiment the automatic response is one or more of modifying a header speed, reducing a vehicle speed, and adjusting a roll gap. In another example, the evaluating the operating conditions includes considering one or more of a header speed, a throw distance, and a header load. In yet another example, the evaluating the operating conditions includes considering at least one input provided from a user input configured to identify a user-preferred speed of the belt of the merger belt assembly.

In yet another example of this embodiment the desired belt speed is a user-selected belt speed selected by a user through a user-interface. In part of this example, the user-selected belt speed is a recommended belt speed generated by the controller based on operating conditions.

In yet another example of this embodiment the automatic response is to shut down the merger belt assembly when the actual belt speed is within a shutdown threshold established by the desired belt speed with the controller.

Yet another embodiment of this disclosure is a method for controlling a merger belt assembly of an agricultural machine. The method includes monitoring operating conditions of the agricultural machine with a controller, setting a desired belt speed of a merger belt of the merger belt assembly based on the operating conditions, comparing an actual belt speed of the merger belt assembly with the desired belt speed, and providing an automatic response when the actual belt speed is outside of a belt speed threshold established by the desired belt speed.

In one example of this embodiment the automatic response includes modifying one or more of the operating conditions.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a vehicle, according to one embodiment;

FIG. 2 is a perspective view of a vehicle including a merger device, according to one embodiment;

FIG. 3 is a perspective view of a vehicle including a merger device, according to one embodiment;

FIG. 4 is a perspective view of a cab of a vehicle, according to one embodiment;

FIG. 5 is a schematic view of a control system, according to one embodiment; and

FIG. 6 is a method flow chart for controlling an vehicle, according to one embodiment.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

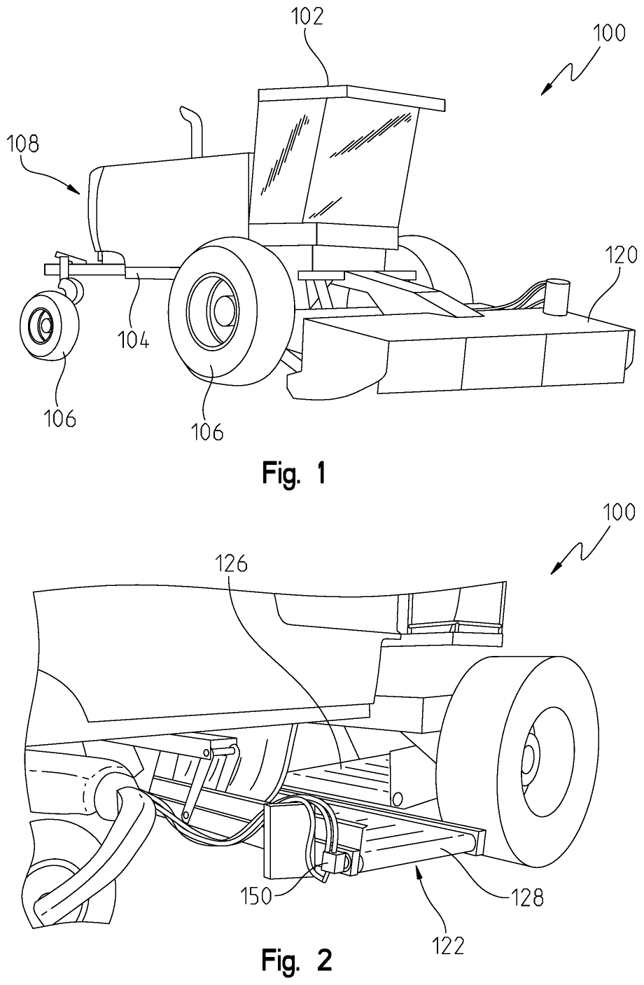

Referring to FIG. 1, an agricultural vehicle 100 is illustrated. The agricultural vehicle 100 may include an automated repositioning system having any one or more of the controllers, sensors, and devices described herein. Although a self-propelled windrower having a dedicated power source 108 is shown in FIG. 1, the present disclosure also considers other self-propelled and pull-type agricultural harvesting equipment, such as cutters, mowers, mower-conditioners, forage harvesters, and combines. The vehicle 100 may include an operator compartment or cab 102 where an operator may direct or control the operation of the vehicle 100. The vehicle 100 may include a frame 104 to which one or more ground engaging apparatus 106, such as wheels or tracks, are operably connected. The vehicle 100 may include a power source and a transmission operably coupled to one or more ground engaging apparatus 106. In one aspect of this disclosure, a vehicle speed control assembly 204 may be selectively controlled by a controller 202 to selectively alter the vehicle speed by automatically managing the power source, transmission, and ground engaging apparatus 106.

The vehicle 100 may include a harvesting device or attachment, such as a harvesting header 120, which can harvests a variety of crops including, but not limited to, hay, corn, and soybeans among other things. The harvesting header 120 can be a rotary header or a draper header controlled by a header assembly 206. The header assembly 206 may be selectively controllable by the controller 202 to alter the speed of either a rotary header or a draper header. Further, the vehicle 100 may include a single harvesting header 120 or multiple harvesting headers 120. The harvesting header 120 may include a lowered or operating position, as shown, and a raised or non-operating position. The harvesting header 120 may include an active or operating condition and an inactive or non-operating condition. In the operating condition, the components of the harvesting header 120 are moving or otherwise operational and selectively controlled by the controller 202 through the header assembly 206.

The harvesting header 120 may direct harvested crop through a roll gap assembly 210. The roll gap assembly 210 may be selectively moveable to alter a gap for crop to pass there through. More specifically, the roll gap assembly 210 may include a conditioning roller and an opposing member that are configured to cooperatively condition a crop material that passes through a gap between the conditioning roller and the opposing member. This gap may be alterable through one or more actuator selectively controlled by the controller 202. The gap provided by the roll gap assembly 210 may be selectively defined through a user selection or automatically controlled with the controller 202. See at least U.S. Pat. No. 10,806,078 for an example of a system for adjusting a gap for conditioning rollers of the harvesting header 120, the contents of which are incorporated herein in entirety.

Referring now to FIG. 2, the agricultural vehicle 100 may include another harvesting device or attachment, such as a merger device 122 having one or more conveyors 126, 128. The merger device 122 may be part of a merger belt assembly 208 and be selectively controlled by the controller 202. The merger device 122 may include a lowered or other operating position and a raised or other non-operating position. The merger device 122 may include an active or operating condition and an inactive or non-operating condition selectively implemented by controller 202 through the merger belt assembly 208. In the operating condition, the one or more conveyors 126, 128 are moving or otherwise operational. The merger device 122 may include a conveyor 126 which receives harvested crop from the harvesting header 120 and delivers the crop to a cross-conveyor 128. The cross-conveyor 128 receives the crop from the conveyor 126 and delivers the crop to either side of the vehicle 100. Additionally or alternatively, the vehicle 100 could include one or more merger devices 122 positioned on or near the rear of the vehicle 100.

The merger belt assembly 208 may have a power source or motor 150 selectively controlled by the controller 202 to move the cross-conveyor or merger belt 128 to distribute crop from the conveyor 126 out one side of the agricultural vehicle 100. The motor 150 may be hydraulic, pneumatic, or electrically powered and is selectively powered by the controller 202 to rotate the merger belt 128 thereabout. In one aspect of this disclosure, the speed and angle of the merger belt 128 may be adjustable such that a throw distance can be modified by the merger belt assembly 208. The throw distance may be the distance harvested material is thrown from the merger belt 128 before it contacts the underlying surface. In view thereof, in one aspect of this disclosure the user may input a desired throw distance through the user input 212 and the controller 202 can adjust one or more of the speed of the merger belt 128 or the angle of the merger belt to accommodate the user-input throw distance.

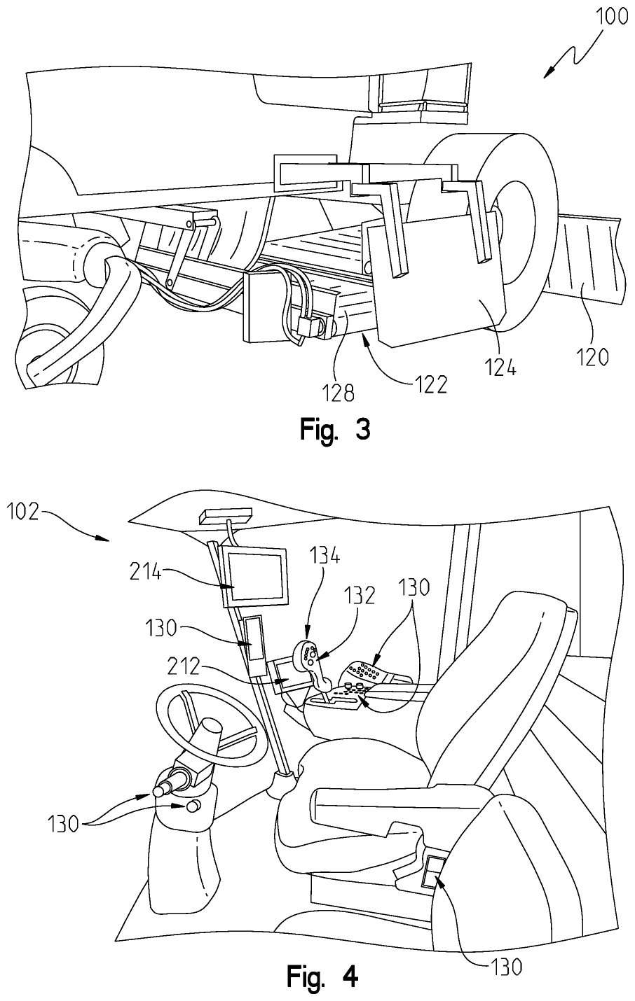

Referring now to FIG. 3, the merger device 122 may include a deflector 124 which can direct the crop after it leaves the cross-conveyor 128. The deflector 124 may include a lowered or operating position, as shown, and a raised or non-operating position. In the lowered position, the deflector 124 engages or directs the crop after it leaves the cross-conveyor 128. In the raised position, the deflector 124 remains disengaged from the flow of crop as it leaves the cross-conveyor 128.

Referring now to FIG. 4, an interior of a cab 102 of the agricultural vehicle 100 is illustrated. The cab 102 may include one or more operator controls 130, such as a direction input device 132, a device selector 134, a user input 212, and a display 214. The direction input device 132 provides an interface for an operator to control the direction of the vehicle 100. The device selector 134 provides an interface for an operator to select or pre-select which devices are to be controlled. Similarly, the user input 212 may be a touch screen or other input device wherein the user can selectively control any of the assemblies 204, 206, 208, 210 discussed herein. Further, the display 214 may provide a visual indicator to the operator about the operating conditions of any of the assemblies 204, 206, 208, 210 of the agricultural vehicle 100 among other things.

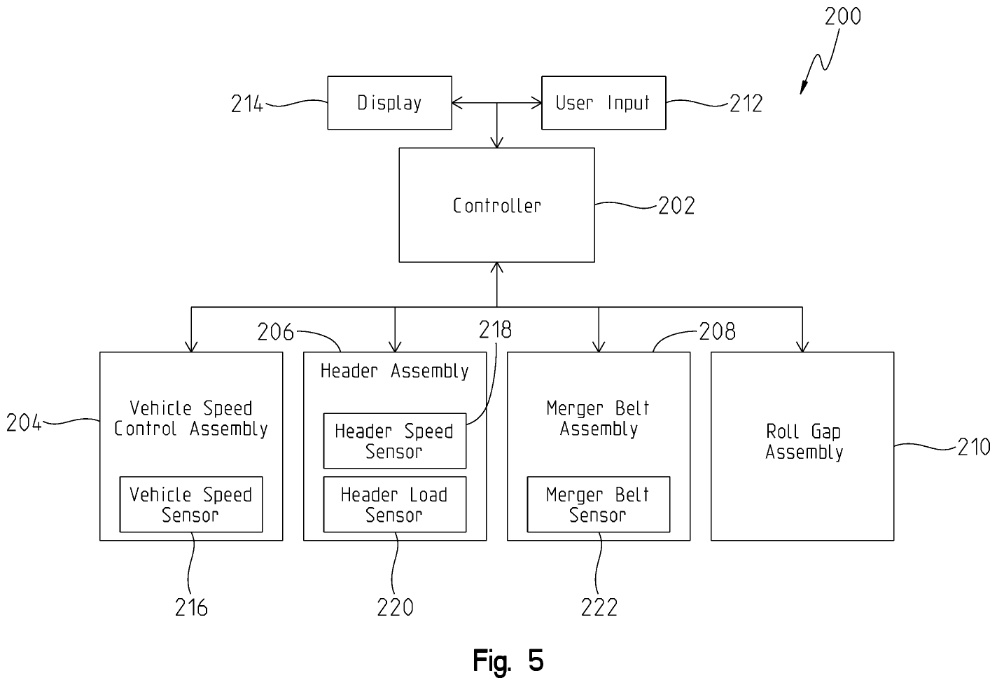

Referring now to FIG. 5, a schematic representation of a control system 200 is illustrated. The control system 200 may selectively control any of the assemblies of the agricultural vehicle 100. More specifically, the controller 202 may be one or more processor with access to a memory unit to store data and execute commands, among other things. The controller 202 may be a standard controller on the agricultural vehicle 100 used to execute common functions for the agricultural vehicle 100. Alternatively, the controller 202 can be a dedicated hardware component for the merger belt assembly 208. In this embodiment, the controller 202 may communicate with one or more other controllers of the agricultural vehicle 100 to implement the teachings discussed herein. In yet another embodiment, the controller 202 may be part of a remote device that communicates wirelessly with the agricultural vehicle 100 to implement the teachings discussed herein. A person skilled in the art understands many different hardware components could be used to implement the methods discussed herein, and this disclosure contemplates using any known hardware or technical methodology for implementing the teachings discussed herein on the agricultural vehicle 100.

The controller 202 may communicate with the vehicle speed control assembly 204 to selectively alter the speed of the agricultural vehicle 100. More specifically, one or more vehicle speed sensor 216 may communicate a vehicle speed to the controller 202. In one embodiment of this disclosure, the controller 202 may selectively manipulate the vehicle speed control assembly 204 to alter the speed of the agricultural vehicle 100. For example, the controller 202 may monitor the vehicle speed sensor 216 alter the vehicle speed with the vehicle speed control assembly 204 to change the vehicle speed to a desired vehicle speed based on the working conditions. In one aspect of this disclosure, the controller 202 may control the vehicle speed control assembly 204 by selectively altering one or more of the power source, transmission, and engaging apparatus 106 of the agricultural vehicle 100 to alter the vehicle speed.

Similarly, the controller 202 may communicate with the header assembly 206 to selectively control one or more components of the harvesting header 120. In the example where the harvesting header 120 is a rotary header, the controller 202 may communicate with a header speed sensor 218 to determine the speed at which the rotary header is rotating. Similarly, the controller 202 may communicate with a header load sensor 202 to determine the load of crop being processed by the harvesting header 120. In one aspect of this disclosure, the controller 202 may selectively alter the operating parameters of the header assembly 206. More specifically, if the header assembly 206 is a rotary header, the controller 202 may selectively alter the rotational speed of the rotors by monitoring the header speed sensor 218 and selectively changing the header speed based on the operating conditions of the agricultural vehicle 100. Similarly, the controller 202 may also monitor the header load sensor 220 to selectively alter things like the speed of conveyor 126 or the speed of a draper assembly if the harvesting header 120 is a draper header. Accordingly, in one aspect of this disclosure the controller 202 can monitor and selectively alter the operating parameters of the header assembly 206.

The controller 202 may also communicate with, and selectively control, the merger belt assembly 208. More specifically, the controller 202 may communicate with a merger belt sensor 222 to identify the operating speed of the merger belt 128. Further, the controller 202 may selectively control the operating speed of the merger belt 128 by altering the speed of the motor 150 of the merger device 122. In view thereof, the controller 202 may both instruct a desired speed of the merger belt 128 through the motor 150 and monitor the actual speed of the merger belt 128 with the merger belt sensor 222.

The controller 202 may also selectively alter the roll gap assembly 210 to provide an ideal roll gap for the operating conditions. In this example, the controller 202 may selectively enlarge, or narrow, the roll gap with the roll gap assembly 210 so the agricultural vehicle 100 is operating under ideal conditions.

The controller 202 may also be in communication with the display 214 to convey to the user any known information about the operating conditions of any of the assemblies 204, 206, 208, 210 among other things. In one example, the display 214 may be a touchscreen display in the cab 102 of the agricultural vehicle 100. Alternatively, the display 214 may not be a touchscreen but rather may be a screen or light or combination of lights configured to provide a visual message to a user in the cab 102. In yet another embodiment contemplated herein, the display 214 may be a wireless device that communicates wirelessly with the controller 202. More specifically, the display 214 may be on a wireless computer such as a laptop, tablet, smartphone, or other similar electronic device.

While the term “display” is used herein for display 214, this disclosure contemplates conveying messages to a user with non-visual means as well. For example, the display 214 may have one or more of audio and haptic feedback for the user as well. In one example, the display 214 only includes one or more of audio and haptic feedback and does not provide a visual message to the user. In other embodiments, the display 214 provides audio, visual, and haptic feedback to the user as instructed from the controller 202. Regardless, the controller 202 can selectively engage the display 214 to provide a message to the user.

The controller 202 may also communicate with the user input 212 to provide desired functions for one or more of the assemblies 204, 206, 208, 210, among other things. For example, the user input 212 can provide an input to the controller 202 indicating a desired vehicle speed, header speed, merger belt speed, merger throw distance, and roll gap distance among other things. The controller 202 may communicate with the user input 212 such that the controller 202 can manipulate one or more of the assemblies 204, 206, 208, 210 responsive to the desired operating parameters input by a user through the user input 212. In one aspect of this disclosure, the display 214 and user input 212 may be the same touchscreen device. Similarly, the user input 212 may be a wireless device that communicates wirelessly with the controller 202. More specifically, the user input 212 may be a wireless computer such as a laptop, tablet, smartphone, or other similar electronic device.

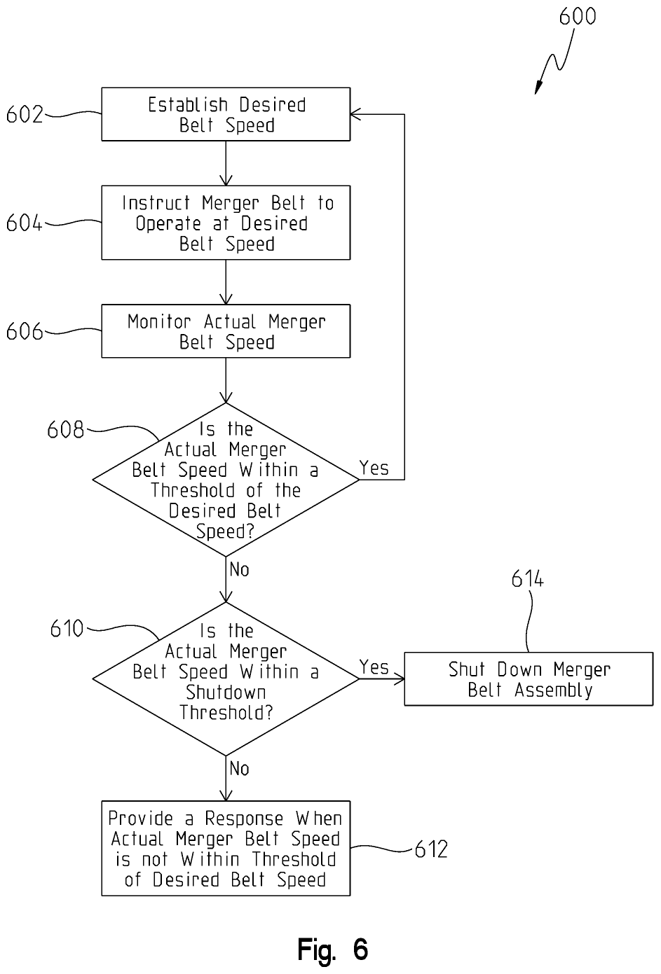

Referring now to FIG. 6, one embodiment of the present disclosure is illustrated. More specifically, FIG. 6 illustrates a method for controlling an agricultural machine having a merger device 600. The method 600 may be implemented by the controller 202 or one or more controller of the agricultural vehicle 100. Alternatively, a remote device in wireless communication with the agricultural vehicle may implement the method 600 discussed herein. The method 600 may be implemented when the agricultural vehicle 100 is in the operational configuration preparing to, or already engaging, the header assembly 206 to harvest crop. In one aspect of this disclosure, the method 600 may commence when a user initiates the method through the user input 212. Alternatively, the method 600 may begin automatically when the agricultural machine 100 is in the operational configuration.

Regardless, in box 602 the controller 202, or an equivalent thereof, may establish a desired belt speed of the merger belt 128 of the merger belt assembly 208. The desired belt speed may be input by the user via the user input 212 or automatically determined by the controller 202 or an equivalent thereof based on the operating conditions of one or more of the assemblies 204, 206, 208, 210. When the desired belt speed is established via the user input 212, the user may engage the user input 212 to set the desired belt speed of the merger belt 128. The user input 212 may provide selectable speeds for the merger belt 128 that the user can select to establish the desired belt speed or the user may input a desired speed within an available speed range (i.e., the desired revolutions per minute of the merger belt 128 within the functional range of the merger belt assembly 208).

The controller 202 may be configured to send a signal to the motor 150 to operate the motor 150 at the desired belt speed. In one example, the controller 202 may have predefined therein the operating parameters of the motor 150 such that the controller 202 may provide a corresponding signal to the motor 150 or a system thereof to operate the motor 150 at the desired speed under normal operating conditions. That is to say, the controller 202 may have predefined operating parameters for the motor 150 that would provide the corresponding desired speed of the merger belt 128 under normal operating conditions when the merger belt 128 is not experiencing increased or unexpected loads. In one example, the motor 150 is a hydraulic or pneumatic motor and the controller 202 may operate one or more valves of an electro-hydraulic or electro-pneumatic system to provide a fluid pressure and flow to the motor 150 to produce the desired speed under normal working conditions. Similarly, if the motor 150 is an electric motor the controller 202 may power the electric motor with sufficient electrical power to generate the desired speed under normal operating conditions.

In one aspect of this disclosure, the controller 202 or an equivalent thereof may provide a recommended belt speed as an option on the user input 212 or display 214 as part of box 602. In this example, the recommended belt speed may be determined by the controller 202 or an equivalent thereof by monitoring or otherwise identifying the operating conditions of one or more of the assemblies 204, 206, 208, 210. More specifically, the controller 202 or an equivalent thereof may identify one or more operating condition such as the vehicle speed from the vehicle speed sensor 216, the header speed from the header speed sensor 218, the header load from the header load sensor 220, the merger belt speed from the merger belt sensor 222, the roll gap from the roll gap assembly 210, and a desired throw distance from the user input 212 among other operating conditions. In this example, the controller 202 or an equivalent thereof may provide a recommended desired belt speed via the display 214 or the user input 212 based on one or more of the operating conditions discussed herein.

In another aspect of this disclosure, the user may input anticipated or desired operating conditions with the user input 212 to allow the controller 202 or an equivalent thereof to generate a recommended desired belt speed in box 602. More specifically, the user may input via the user input 212 or other similar device the expected or desired operating conditions of the agricultural vehicle 100. The expected or desired operating conditions may include the vehicle speed, header speed, header load, roll gap, and throw distance among other things. The user may input values for one or more of these operating conditions and the controller 202 or an equivalent thereof may generate a recommended desired belt speed in box 602.

The desired belt speed may also be determined automatically by the controller 202 or an equivalent thereof. In this example, the desired belt speed may be established based on the operating conditions of the other assemblies 204, 206, 208, 210 among other things. For example, the desired belt speed may be established by the controller 202 or an equivalent thereof by considering one or more of the speed of the agricultural vehicle 100, the header speed or header load of the header assembly 206, and the roll gap of the roll gap assembly 210 among other things. In one example, the controller 202 or an equivalent thereof may have a lookup table that correlates a desired belt speed of the merger belt 128 with one or more of the operating conditions of the assemblies 204, 206, 208, 210. Alternatively, the controller 202 or an equivalent thereof may use an algorithm or other equation to determine the desired belt speed of the merger belt 128 in box 602. Regardless, in box 602 the controller 202 or an equivalent thereof may establish a desired belt speed either through a user input or an automatic process based on information from the other assemblies 204, 206, 208, 210.

In box 604, the controller 202 or an equivalent thereof may instruct the agricultural machine 100 to operate the merger assembly 206 at the desired belt speed. More specifically, in one example the controller 202 may instruct a hydro-electric system to rotate the motor 150 such that the merger belt 128 rotates at the desired belt speed established in box 602. Similarly, in another example the controller 202 may instruct an electrical system utilizing electric motors to rotate the motor 150 such that the merger belt 128 rotates at the desired belt speed established in box 602. Further still, in another embodiment the controller 202 may instruct an electro pneumatic system to rotate the motor 150 such that the merger belt 128 rotates at the desired belt speed established in box 602. Regardless of the system type, in box 604 the controller 202 or an equivalent thereof instructs the merger belt assembly 208 to rotate the merger belt 128 at the desired belt speed from box 602.

After the controller 202 or an equivalent thereof has engaged the merger belt assembly 208 to rotate the merger belt 128 at the desired speed in box 604, the controller 202 or an equivalent thereof may monitor the merger belt sensor 222 to identify an actual belt speed of the merger belt 128 in box 606. The actual belt speed may be the speed at which the merger belt 128 is actually rotating in the merger belt assembly 208. In other words, the actual belt speed may be the measured speed of the merger belt 128 as observed by the merger belt sensor 222.

In box 608, the controller 202 or an equivalent thereof can compare the actual merger belt speed determined in box 606 with the desired belt speed established in box 602 to determine whether the amount of belt slip that is occurring in the merger belt assembly 208. As used herein, “belt slip” may refer to the difference between the actual merger belt speed and the desired belt speed. In one aspect of this disclosure, belt slip may be identified as a percentage variance of the actual belt speed compared to the desired belt speed. In one example, the threshold of box 608 may be any actual belt speed that is within ten percent of the desired belt speed from box 602. Alternatively, the threshold of box 608 may be preset values that are associated with user-selectable desired belt speeds from box 602.

While the threshold of box 608 is described herein in one example as ten percent of the desired belt speed, other percentages are contemplated herein as well. For example, in another embodiment the threshold percentage may be more than ten percent the desired belt speed. Further still, in other embodiments the threshold percentage may be less than ten percent the desired belt speed. Accordingly, this disclosure contemplates utilizing any threshold that may be reasonable for an agricultural machine 100 having a merger belt assembly 208.

In another aspect of this disclosure, the threshold value used in box 608 may be a user-selectable value. For example, the user may use the user input 212 to communicate a user-desired threshold value to be applied in box 608. The controller 202 may store the user-desired threshold value in a memory unit and use the user-desired threshold value in box 608. Accordingly, one aspect of this disclosure allows a user to establish the threshold value applied in box 608.

If the actual merger belt speed is within the threshold in box 608, the controller 202 or an equivalent thereof may continue to execute boxes 602, 604, 606 to ensure the merger belt assembly 208 continues operating as expected within the threshold of the desired belt speed.

If the actual merger belt speed is not within the threshold of the desired belt speed in box 608, the controller 202 or an equivalent thereof may check if the actual merger belt speed is within a shutdown threshold in box 610. The shutdown threshold may be based on the desired belt speed established in box 602 and be such that when the actual speed is within the shutdown threshold it is an indication that the merger belt assembly 208 is being overloaded and unable to move the merger belt 128 at a sufficient speed to continue. In one example, the shutdown threshold may be a speed that is only ten percent or less of the desired belt speed established in box 602. However, this disclosure also considers shutdown thresholds that are greater than ten percent the desired belt speed and shutdown thresholds that are less than ten percent the desired belt speed.

Regardless, if the actual merger belt speed is within the shutdown threshold in box 610, the controller 202 or an equivalent thereof may shut down the merger belt assembly 208 and quit directing power to the motor 150 powering the belt 128 in box 614. In addition to shutting down the merger belt assembly 208, other embodiments of this disclosure contemplate altering any of the other assemblies 204, 206, 210 responsive to the actual merger belt speed being in the shutdown threshold in box 610. Accordingly, in one aspect of this disclosure the controller 202 or an equivalent thereof may automatically slow or stop any of the assemblies 204, 206, 208, 210 discussed herein when the actual merger belt speed is within the shutdown threshold in box 610.

While box 610 is discussed herein to compare the actual merger belt speed to a shutdown threshold, other embodiments considered herein may omit this step. Accordingly, box 610 is only one example of a step contemplated by this disclosure and may not be included in alternative embodiments.

If the actual merger belt speed is not within the threshold of the desired belt speed in box 608, or the shutdown threshold of box 610 when utilized, the controller 202 or an equivalent thereof may provide a response in box 612. In one aspect of this disclosure, the response from box 612 may be a visual indication provided on the display 214 indicating to the user that the actual merger belt speed measured by the merger belt sensor 222 is not within the thresholds of box 608, or 610 when utilized. The visual indication may be in the form of an illuminated light or a graphic that indicates to the user that the actual merger belt speed is not within the threshold of the desired belt speed. Alternatively, the response of box 612 may be an audible noise or haptic feedback that can be perceived by the user to indicate the actual merger belt speed is not within the threshold of the desired belt speed.

In another aspect of this disclosure, the response of box 612 may be modifying one or more operating condition of one or more of the assemblies 204, 206, 208, 210. In one example, the response of box 612 may be automatically controlling the vehicle speed control assembly 204 to slow the agricultural vehicle 100 with the controller 202 or an equivalent thereof when the actual merger belt speed is not within the threshold of the desired merger belt speed. In another example, the response of box 612 may include automatically controlling the header assembly 206 to slow the header speed or draper speed with the controller 202 or an equivalent thereof when the actual merger belt speed is not within the threshold of the desired merger belt speed. In another example, the response of box 612 may include automatically controlling the merger belt assembly 208 to increase the merger belt speed with the controller 202 or an equivalent thereof when the actual merger belt speed is not within the threshold of the desired merger belt speed. In yet another example, the response of box 612 may include automatically controlling the roll gap assembly 210 to adjust the roll gap with the controller 202 or an equivalent thereof when the actual merger belt speed is not within the threshold of the desired merger belt speed. In yet another example of this disclosure, the response of box 612 may include modifying more than one of the assemblies 204, 206, 208, 210 with the controller 202 or an equivalent thereof when the actual merger belt speed is not within the threshold of the desired merger belt speed.

In use, one embodiment of this disclosure allows the user to input the desired belt speed of the merger belt assembly 208 via the user input 212 before or while initiating a harvesting operation of the agricultural vehicle 100. The controller 202 will then instruct the motor 150 of the merger belt assembly 208 to rotate the merger belt 128 at the user-input desired belt speed. The controller 202 will monitor the actual belt speed of the merger belt 128 with the merger belt sensor 222. If the actual speed of the merger belt falls outside of a threshold of the desired merger belt speed (i.e., more than ten percent variance between actual merger belt speed and the desired merger belt speed), the controller 202 may automatically provide a response. The response may include one or more of providing an indication of the issue on the display 214, modifying the vehicle speed with the vehicle speed control assembly 204, modifying the operating conditions of the header assembly 206, modifying the conditions of the merger belt assembly 208, and adjusting the gap of the roll gap assembly 210.

In yet another use embodiment, the controller 202 may present one or more efficient set point values for the desired merger belt speed to the user through the display 214 or the user input 212. The one or more efficient set point values are presented to the user for the user to select the desired belt speed from those presented. In this example, the controller 202 may consider the current operating conditions or user-input operating conditions of the agricultural machine 100 when the controller 202 presents the one or more efficient set point values. For example, the controller 202 may consider one or more of the gap of the roll gap assembly 210, the user-selected throw distance of the merger belt assembly 208, the speed or expected load of the header assembly 206, and the desired or current vehicle speed when determining the one or more efficient set point values for the desired merger belt speed. Then, the user may select one of the presented efficient set point values for the desired merger belt speed. The controller 202 may then execute the method 600 discussed herein based on the user selected desired belt speed.

In another use embodiment, the user may set the desired merger belt speed to be automatically determined by the controller 202. In this embodiment, the controller 202 may set the desired merger belt speed to any speed that will provide the desired results based on the operating conditions. For example, if the agricultural vehicle 100 increases the speed of travel, the controller 202 may automatically increase the desired merger belt speed correspondingly. Similarly, if the controller 202 identifies that the actual merger belt speed is slowing relative to the desired merger belt speed, the controller 202 may increase the desired belt speed to increase the amount of harvested material that can be processed by the merger belt assembly 208. Similarly, the controller 202 may automatically adjust the desired merger belt speed if the gap of the roll gap assembly 210 changes. In one aspect of this embodiment, the controller 202 may also automatically adjust any of the assemblies 204, 206, 208, 210 when the operating conditions would result in the actual belt speed falling outside of the threshold of the desired belt speed. Among other things, the controller 202 could automatically do one or more of decrease header speed, increase merger belt speed, reduce vehicle speed, and adjust the roll gap.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A system for controlling an agricultural machine, comprising:
a merger belt assembly comprising a merger belt;
a controller configure to selectively control the merger belt assembly; and
a user input configured to provide a desired belt speed command to the controller indicating a desired operating speed of the merger belt;
wherein the controller is configured to provide instructions to the merger belt assembly of the agricultural machine to operate the merger belt at the desired operating speed;
wherein the controller is configured to monitor an actual merger belt speed of the merger belt assembly and provide a response when the actual merger belt speed is outside of a desired operating speed threshold established by the desired belt speed command.

2. The system of claim 1, wherein the controller is configured to provide one or more of decreasing a header speed, increasing a merger belt speed, reducing a vehicle speed, and adjusting a roll gap as the response.

3. The system of claim 2, wherein the controller is configured to automatically execute the response.

4. The system of claim 1, wherein the controller is configured to provide a recommended belt speed to a user via a display.

5. The system of claim 4, wherein the controller is configured to determine the recommended belt speed based on operating conditions of the agricultural machine.

6. The system of claim 5, wherein the controller is configured to consider one or more of a header speed, a vehicle speed, and a roll gap as operating conditions of the agricultural machine.

7. The system of claim 1, wherein the controller is configured to automatically adjust the desired operating speed as part of the response.

8. The system of claim 7, wherein the controller is configured to automatically adjust the desired operating speed based on operating conditions of the agricultural machine.

9. The system of claim 8, wherein the controller is configured to consider one or more of a header speed, a belt slip, a vehicle speed, and a roll gap for the operating conditions.

10. The system of claim 1, wherein the controller is configured to determine the desired belt speed command from data from the agricultural machine, the data comprising one or more of a header speed, a throw distance, and a header load.

11. The system of claim 10, wherein the data comprises the throw distance and the throw distance is input by a user through the user input.

12. A method for managing a merger belt speed of a merger belt assembly on an agricultural machine, the method comprising:
evaluating operating conditions of the agricultural machine with a controller;
determining a desired belt speed of a belt of the merger belt assembly with the controller based on the operating conditions;
instructing the merger belt assembly to operate the belt at the desired belt speed with the controller;
monitoring an actual belt speed of the belt of the merger belt assembly with the controller through a sensor;
identifying when the actual belt speed is not within a threshold established by the desired belt speed with the controller; and
generating an automatic response on the agricultural machine with the controller when the desired belt speed is not within the threshold.

13. The method of claim 12, wherein the automatic response is one or more of modifying a header speed, reducing a vehicle speed, and adjusting a roll gap.

14. The method of claim 12, wherein evaluating the operating conditions comprises considering one or more of a header speed, a throw distance, and a header load.

15. The method of claim 12, wherein evaluating the operating conditions comprises considering at least one input provided from a user input configured to identify a desired speed of the belt of the merger belt assembly.

16. The method of claim 12, wherein the desired belt speed is a user-selected belt speed selected by a user through a user-interface.

17. The method of claim 16, wherein the user-selected belt speed is a recommended belt speed generated by the controller based on operating conditions.

18. The method of claim 12, wherein the automatic response is to shut down the merger belt assembly when the actual belt speed is not within a shutdown threshold established by the desired belt speed with the controller.

19. A method for controlling a merger belt assembly of an agricultural machine, comprising:
monitoring operating conditions of the agricultural machine with a controller;
setting a desired belt speed of a merger belt of the merger belt assembly based on the operating conditions;
comparing an actual belt speed of the merger belt assembly with the desired belt speed; and
providing an automatic response when the actual belt speed is outside of a belt speed threshold established by the desired belt speed.

20. The method of claim 19, wherein the automatic response comprises modifying one or more of the operating conditions.
